(19) United States
(12) Patent Application Publication
(10) Pub. No.: US 2007/0054211 A1
(43) Pub. Date: Mar. 8, 2007

(54) Chemically derived toner containing sublimation dyes

(75) Inventors: Bing R. Hsieh, Webster, NY (US); Donald E. Snyder JR., Spencerport, NY (US)

Correspondence Address: FAY SHARPE LLP, 1100 SUPERIOR AVENUE, SEVENTH FLOOR, CLEVELAND, OH, 44114, US

(73) Assignee: Nu-kote International, Inc.

(21) Appl. No.: 11/220,758

(22) Filed: Sep. 7, 2005

(51) Int. Cl. G03G 9/09

(52) U.S. Cl. 430/108.23; 430/108.1; 430/108.21; 430/137.15; 430/137.1

(57) ABSTRACT

There is provided a toner composition including a sublimable dye and an optional non-sublimable pigment to produce full color imaging on all of the print engines commonly in use. The toner includes comprising a polymer binder, a wax, a charge control agent, a sublimable dye, and a non-sublimable pigment. The toners formed have stable and controllable triboelectric properties and also have acceptable toner ruboff properties.

### BACKGROUND

The present exemplary embodiments relate to chemically produced toner compositions. It finds particular application in conjunction with toner compositions for use with laser printers, electrophotographic or electrostatic recording or printing devices, and will be described with particular reference thereto. However, it is to be appreciated that the present exemplary embodiment is also amenable to other like applications such as copiers and the like.

The imaging of textiles and other materials using thermal transfer of sublimable dyes has been commercially practiced for more than 50 years. Creating the images to be transferred has been accomplished using established imaging technologies such as off-set press, silk screen, and ink jet methods, or the like. The image is usually formed on paper using inks containing sublimable dye colorants. The transfer paper decals are then brought into contact with the textile or other material to be decorated and, with the application of heat and pressure, the dye is vaporized and transferred as a gas to the receptor. A permanent image is thereby formed.

With the introduction of laser printers for use with personal computers, attempts were made to incorporate thermal transfer sublimable dyes into the toners used in these printers with only limited success. The printers were intended to image in only one color, particularly black. However, when a toner was properly formulated for this application and a sublimable dye was incorporated into the toner, images could be formed which could then be thermally transferred by the application of sufficient heat to vaporize the dye. By this method, a single color image could be formed. Since many of these laser printers used replaceable cartridges to carry the toner to form the image in this electrophotographic process, various of these special thermal transfer toners could be installed in several cartridges, including toners containing the process color dyes for cyan, magenta, and yellow color imaging. Using a color separation program on a personal computer connected to such a laser printer, a skilled operator could effectively create a color separation of a full color image and print each separation by installing in turn the appropriate cartridge containing the indicated color-cyan, magenta, or yellow. By this method, an image containing the appropriate cyan, yellow and magenta thermal transfer dyes can be stepwise constructed. Nevertheless, such a process is extremely time consuming.

More recently, process color laser printers and copiers have been introduced and have gained some commercial acceptance. However, because the computer technology needed to adapt process color to these printers is relatively new, the printers and copiers are still relatively expensive, thus hindering their widespread use to date.

Given this, there has not been much interest in the preparation of after market toners for these machines by independent producers. Therefore, to date there has been little research successfully completed regarding solving the technical problems associated with preparation of suitable color toners, particularly those incorporating thermal transfer sublimable dyes. This lack of interest and effort is due not only to the small, fragmented market, but even more so to the difficult technical challenge that must be addressed by one in this area, i.e., one must solve not only the problems of making a single color toner, but also the problem of making all four color toners which will function well individually while establishing and maintaining a proper color balance between the various color toners during use.

In order to formulate process color thermal transfer dye sublimation toner for use in one or more of the commercial color laser printers or copiers, one must understand the process, chemistry and requirements for functional toners for use in the aforementioned machines. One must use this knowledge to develop a functional set of color balanced toners containing sublimable dyes. This requires an understanding and knowledge of the different chemistry involved in the use of sublimable dyes. In addition, the primary images formed using the above-mentioned toners must be suitable for making secondary images on a suitable receptor substrate using conventional dye sublimation thermal transfer methods, i.e., only the dye must transfer, and the toner must stay on the transfer sheet.

A thorough study of the existing color toner technology reveals that the majority of color toner systems in use today are formulated with low melt viscosity, mostly linear polyester resins. It has been found that toners formulated to meet the imaging requirements of the standard toners, as used in the popular commercially successful color laser printers and copiers, which generally employ such low viscosity, often polyester, polymers, are too tacky and sticky for use in making dye sublimation transfer sheets used at the elevated temperatures needed to cause vaporization of the dyes.

Given the foregoing, it becomes clear, as stated above, that there are major concerns confronting the skilled artisan attempting to formulate a commercially useful set of process color thermal transfer dyes sublimation toners. To reiterate these concerns, first, one must have knowledge of practical toner formulating, an understanding of color electrophotography and an understanding of color toner technology. Second, one must successfully incorporate thermal transfer sublimation dyes into a totally functional set of toners for use in a commercial color laser printer or copier. And third, one must formulate the toners to function as dye sublimation thermal transfer decals without mass transfer of the toner resin to the secondary substrate.

The most difficult problem is that relating to transferring only the dye to the secondary substrate. For nearly two decades toners have been formulated to retard their inherent tendency to adhere to hot surfaces. At least three approaches to solving this problem are in use in conventional toners today. As taught by U.S. Pat. No. Re31,072 to Jadwin, high molecular weight and especially cross linked polymers may be used. Another means of solving this problem involves the incorporation of internal lubricating agents, such as waxes. A third solution is the incorporation of inert, preferably organic fillers, such as metal oxides, carbonates and the like, to act as flatting agents and which retard tack in most resins.

Attempts at the inclusion of sublimable dyes into toners are seen for example, in U.S. Pat. Nos. 5,555,813 and 4,536,462. U.S. Pat. No. 5,555,813 describes a toner containing a sublimable dye intended for use in the preparation of images to be transferred to a secondary substrate. This patent teaches, however, that in order to transfer the sublimable dye component a molecular sieve, preferably a zeolite, must be included in the toner composition to assist in dye transfer. The molecular sieve retains the dye in its voids and then transfers the dye upon heating at elevated temperatures. U.S. Pat. No. 4,536,462 also discusses the use of sublimation dyes to prepare toner compositions. The toner is a monochrome, magnetic toner product. This teaching requires the inclusion of a surfactant in the composition in order to achieve good image development. As these patents demonstrate, the inclusion of sublimation dyes into toners for color processing requires special considerations.

Transfer sheet printing may be enhanced by the use of sublimation dye colorants. The resins historically used in the process printing and copying industry, however, are not suitable for use when the dye component to be transferred by the process is a sublimation dye. These dyes require the application of high temperatures in order to sublime. The linear polymer resins normally included in toner products, to assure proper colorant dispersion and image quality, and which are well suited for today's most popular printers and copiers, become very tacky and sticky at the elevated temperatures required to sublime the disperse dyes, making clean transfer of the dye alone impossible.

During use in an electroreprographic device, friction between particles of toner with their carrier and/or with parts of the device in which the toner is used cause the toner particles to become charged with an electrostatic charge (tribocharge). The exact mechanism to produce the toner image will then vary according to the specific device used. For example in a conventional photocopier the toner composition may be formulated so that tribocharged toner particles will be opposite in sign to the latent image on the drum and toner will be attracted to the latent image on the drum to develop an image in toner on the drum which corresponds to the original document. The developed image is then transferred to a substrate such as paper (e.g. by a pressure roller and/or voltage). The transferred image is fixed to the substrate (e.g. by heat, pressure and/or suitable solvents) to produce a hard copy of the image. The image drum is then cleaned and the device is ready to produce the next copy. Thus developer compositions are used both to develop the latent image on the drum and to produce the final hard copy.

Control of tribocharging characteristics of toners plays an important role in electrophotography. Tribocharge of toners and polymer particles are influenced by many factors such as particle size, resistivity of particles, temperature, humidity, etc. It has remained difficult to control the tribocharging of toners containing sublimation dyes. Thus, it would be beneficial if one could easily control this characteristic.

It has remained for this invention to provide toners which meet the above mentioned requirements of excellent functionality as electroscopic toners in various commercial color laser printers and copiers, which contain a balanced set of sublimable dyes, which allow for the controlling of the tribocharging characteristics of the resulting toner.

### BRIEF SUMMARY

The present embodiments relate to a means whereby full process color imaging may be accomplished using sublimable dyes and non-sublimable pigments. Further, the embodiments may take form in a toner composition including a sublimable dye to produce full color imaging on all of the print engines commonly in use. The present embodiments relate to toner formulations preferably having stable triboelectric properties and also having acceptable toner ruboff properties.

### DETAILED DESCRIPTION

The present embodiments relate to toner compositions suitable for use in developing electrostatic images by electrophotographic, electrostatic recording and printing processes. More particularly, the present embodiments are directed to black or color toner compositions having sublimation colorants with optional non-sublimation colorants for use in process laser printers and copiers, and to the use of these toners to produce process images suitable for transfer to secondary substrates, wherein a sublimation dye is transferred to the substrate. The invention takes form in a black or color toner formulation which is compatible with all types of process color printers and copiers, including laser jet devices, and which does not experience the potential problem of off-set.

The toner product has particular application to the field of transfer images. For example, the toner described hereinafter is particularly well suited to the production of images on a primary substrate, usually a paper-type material, which is then used in a further imaging process, at elevated temperature, whereby the image is transferred from the primary substrate onto a secondary substrate. The secondary substrate may be made of any material. For instance, the image may be transferred to a t-shirt or other item comprised of a fabric-type material or other textile, such as a tote bag, golf towel, ball hat, scarf etc. Further, the images printed on the primary substrate may be applied to coated ceramic, metal or other substrates, which may take the form of coffee mugs, wall plaques, desk top items, and any number of other items which are generally used to carry transfer decals. A wide selection of preferred final substrates is possible, including, but not limited to, textiles, and especially natural, semi-synthetic or synthetic materials. Examples of natural textile materials include wool, silk, hair and cellulosic materials, particularly cotton, jute, hemp, flax and linen. Examples of synthetic and semi-synthetic materials include polyamides, polyesters, polyacrylonitriles and polyurethanes. Textile materials may be a blend of natural and synthetic fibers, as well.

The toner product contains sublimation dyes, or disperse dyes, and optional non-sublimable pigments as the coloring component. Both the sublimation dyes and the pigment are contained in the toner and are transferred to the primary substrate, or transfer sheet, along with the toner product. Subsequently, on the application of elevated temperatures to the toned image, the dye component sublimes and is transferred to the secondary substrate to produce a black or color image having exceptional clarity, sharpness, brightness, and other desirable image qualities. Transfer of the dye component alone is important to the “hand” of the transferred image, and also enhances the visual characteristic of the transferred image.

Because it is preferred that only the sublimable colorant transfer to the secondary substrate, it is preferred that the remaining toner components be unaffected by the application of the high temperatures at which disperse dyes sublime. As was stated previously, lower molecular weight linear polymer resin components, which are the resins of choice almost exclusively for the color printers and copiers used today, get tacky at higher temperatures and will transfer to the substrate along with the dye component. This is the case with most current transfer sheets, as is evidenced by the fact that most current transfer sheets appear clean after transfer of the printed image to a secondary substrate, i.e., the entire toner compound has been transferred.

Thus, the toner newly developed and disclosed herein preferably employs a high molecular weight polymer resin. Usually, polymer materials are classified by those skilled in the art as having low, intermediate, and high molecular weight. The high molecular weight polymer materials generally have a molecular weight above about 50,000, and preferably above about 100,000. In the case of linear polymers, the lower end of this molecular weight range may extend down to about 50,000, though suitability for secondary thermal transfer use may be limited at this molecular weight to only certain types of substrates. High molecular weight polymer materials do not melt and become tacky at the temperatures needed to cause sublimation of the disperse dye components, and therefore are not likely to transfer freely to the secondary substrate.

Controlling the polymer molecular structure can also reduce toner transfer to secondary substrate. At a similar molecular weight, branched or crosslinked polymers have less tendency to transfer as compared to the linear counterparts.

Some examples of known polymer materials generally used in toner compositions and suited as well for use herein due to there high molecular weight include: polyamides, polyolefins, styrene acrylates, styrene methacrylates, styrene butadienes, cross-linked styrene polymers, polyesters, cross linked polyester epoxies, polyurethanes, vinyl resins, including homopolymers or copolymers of two or more vinyl monomers; and polymeric esterification products of a dicarboxylic acid and a diol comprising diphenol. Vinyl monomers include styrene, p-chlorostyrene, unsaturated mono-olefins such as ethylene, propylene, buytlene, isobutylene, and the like; saturated mono-olefins such as vinyl acetate, vinyl propionate and vinyl butyrate; vinyl esters such as esters of monocarboxylic acids, including methyl acrylate, ethyl acrylate, n-butylacrylate, isobutyl acrylate, dodecyl acrylate, n-octyl acrylate, phenyl acrylate, methyl methacrylate, ethyl methacrylate, and butyl methacrylate; acrylonitrile, methacrylonitrile, acrylamide, mixtures thereof; and the like. Examples of specific thermoplastic toner resins include styrene butadiene copolymers with a styrene content of from about 70 to about 95 weight percent. Additionally, cross linked resins, including polymers, copolymers, and homopolymers of the aforementioned styrene polymers may be selected.

In one exemplary embodiment, cross-linked high molecular weight polymer resins, particularly cross-linked polyester resins are used. As was noted above, however, any high molecular weight polymer material compatible with the mechanics and operational parameters of the printer/copier in which the toner is intended to be used may be employed.

Also of interest, with regard to another exemplary embodiment, are high molecular weight linear polymer resins in accord with the resins listed hereinabove. Of the general types of resins which comprise that list, linear polymers which will perform in an acceptable manner as part of a color toner intended for use in secondary transfer imaging exhibit the high molecular weight set forth herein, which is to say in the case of linear polymers that the molecular weight (M_{w}) of the polymer be at least about 50,000 or above, preferably at least about 100,000 or above, and most preferably at least about 300,000 or above.

The toner further contains as a first component of the colorant a sublimable dye. Such dyes are commonly referred to in the industry as disperse dyes. These dyes generally sublime at a temperature between 120° C. and 220° C., possibly up to 300° C. Suitable dyes, classified under the title “Disperse Dyes”, generally chemically belong to groups comprising nitroarylamine, azo and anthraquinone compounds. Generally, they contain an amino group and do not contain a solubilizing sulfonic group.

Suitable dyes include but are not limited to Intratherm Yellow P-1343NT, Intratherm Yellow P-1346NT, Intratherm Yellow P-346, Intratherm Brilliant Yellow P-348, Intratherm Brilliant Orange P-365, Intratherm Brown P-1301, Intratherm Dark Brown P-1303, Intratherm Pink P-1335NT, Intratherm Brilliant Red P-1314NT, Intratherm Red P-1339, Intratherm Blue P-1305NT, Intratherm Blue P-1404, C.I. Disperse Blue 359, Intratherm Orange P-367 Intratherm Brilliant Blue P-1309, C.I. Disperse Red 60, Intratherm Yellow P-343NT, C.I. Disperse Yellow 54, Disperse Blue 60, C.I. Disperse Yellow 82, C.I. Disperse Yellow 54, 10 C.I. Disperse Yellow 3, C.I. Disperse Yellow 23, C.I. Disperse Orange 3, C.I. Disperse Orange 25, C.I. Disperse Orange 7, C.I. Disperse Orange 1, C.I. Disperse Red 1, C.I. Disperse Red 60, C.I. Disperse Red 13, C.I. Disperse Violet 1, C.I. Disperse Blue 14, C.I. Disperse Blue 3, C.I. Disperse Blue 359, C.I. Disperse Blue 19, C.I. Disperse Blue 134, C.I. Disperse Blue 72, C.I. Disperse Blue 26, C.I. Disperse Blue 180, and other suitable dye materials. Such materials are available commercially from Keystone Aniline Corporation, Crompton & Knowles, BASF, Bayer, E. I. du Pont de Nemours & Co., Ciba, ICI, and others. In the foregoing, it is important only that the dye chosen be thermally and chemically stable, be compatible with the polymers in the toner particles and with any other toner additives, and be colorfast.

The toner contains as an optional second component of the colorant a non-sublimable pigment. This non-sublimable pigment component may include carbon black and/or an organic pigment such as an azo pigment, phthalocyanines, or quinacridones. The use of a non-sublimable pigment in addition to the sublimable dye allows more efficient and better control of tribocharging characteristics of the resulting toners, which plays an important role in electrophotography.

The toner may also contain a wax component to aid the anti-stick properties of the toner. Various natural and synthetic waxes may be used, such as carnauba wax, and polyethylene and polypropylene, and other natural and synthetic wax or wax-like materials available commercially from a number of suppliers. For example, in the preferred embodiment of the toner product an amide wax component is used, particularly an ethylene bis(stearamide).

The toner containing the foregoing binder polymer, disperse or sublimation dye, pigment, and wax will likely further include such additives as charge control agents, flow aids, and other known additives, all particular to the machine or engine in which the toner will be used.

Charge control agents are added to a toner for the purpose of making the toner product either more electronegative or more electropositive. The purpose of the charge control agent component of the toner is to stabilize the toner with respect to electrical charge and thus avoid problems of print quality, color balance, and fogging, which are associated with too much or too little charge on the toner particles.

Charge control agents are generally metal-containing complexes or nitrogen containing compounds, and impart a desired charge to the toner, which either counteracts the charge imparted by other toner components or enhances the same, depending on the components and the agent used. Charge control agents suitable for use in the inventive toner product herein include negative charge control agents such as those commercially available from Orient Chemicals under the trade designations S-34, S-37, E-81, E-84, and E-88, those available from Hodagaya Chemical under the trade designations TRH, T-77, T-95 and TNS-2, those available commercially from Japan Carlit under the trade designations LR-147, and LR-120, those available from Zeneca under the trade designation CCA-7, and other such materials available from BASF and others.

Commercially available positive charge control agents, which may also be used, include nigrosine compounds available commercially from Orient Chemicals under the trade designation N-01, N-02, N-03, N-04, N-05S, N-06, N-07, N-08, N-09, N-10, N-11, N-12 and N-13, and cetyl pyridinium chloride (CPC) available commercially from several suppliers, and other quaternary ammonium compounds. These and other similar commercially available charge control agents may be selected. Generally, the charge control agent is included in the toner composition as up to about 10% thereof, based on the weight of the toner.

Plasticizers may also be included in the toner compositions. Useful plasticizers include both very low viscosity plasticizers and polymeric plasticizers that are liquid at room temperature. These low viscosity plasticizers can be used alone or as part of a mixture of low viscosity plasticizers. Typical examples of useful plasticizers include dimethylphthalate, dibutylphthalate, tributylphosphate, butylstearate, ethyleneglycolbutyletheracetate, diethyleneglycolethyletheracetate, and diethyleneglycolbutyletheracetate. The amount of plasticier included in the toner is preferably from about 0 wt % to about 5 wt %, based on the toner composition.

The toner may further contain additives to aid in retarding tack filler material. This material is preferably an inorganic material such as various metal oxides or carbonates or equivalent materials which will perform in the same manner. For example, silicon dioxide, titanium dioxide, aluminum oxide, calcium carbonate, barium sulfate, cerium oxide, iron oxide, strontium titanate, and other such materials may be used.

Unlike conventional color toner products, the present toner containing a sublimation dye and the optional non-sublimable pigment will ultimately transfer only the dye component of the toner. Therefore, while colorlessness of the charge control agent is imperative for conventional color toners, the toner product which is the subject hereof may employ any suitable agent, regardless of the color thereof. Thus, any color in the charge control agent is negligible. Further, the agent may be negative or positive depending on the print engine, the toner components, and the system parameters.

The toner of the present invention may further include external additives employed for the purpose of enhancing flowability of the toner product. The additive used may be a single component additive or may be a specific combination of additives, the combined use of which produces a special performance effect of the toner product. Additives may be selected from silicas, metal stearates, fluoropolymer powders, fine polymer powders, rare earth oxides, waxes, conductive particles, magnetite, carbon, and titanates, and other like compounds.

Post additive treatment agents, such as flowability enhancers of the type used in this toner product, result in deagglomeration of the toner particles in use, and enhanced stability during storage of the toner product. In selecting a flowability enhancing additive to be added to the toner product during a post-treatment step, it is important to consider these parameters: anti-caking; flowability; electrostatic charge; stability; coefficient of friction; transfer efficiency; photoreceptor release properties; hydrophobicity; storage stability; and others. The indication of these characteristics generally requires inorganic compounds of fine particle size and high surface areas. These additives are often treated to render them hydrophobic in order to overcome the drawbacks associated with their conventionally hydrophilic nature.

For example, as the post additive to be employed in production of a toner in keeping with the present invention there may be used a hydrophobic silica fine powder in combination with a hydrophobic titanium oxide powder. Preferably, the titanium oxide powder is a silane treated powder. Other suitable external additives, or post additives, may include but are not limited to the use of aluminum oxide; zinc oxide; cerium oxide; strontium titanate; iron oxide; ferrite powder; calcium carbonate; copper oxide; barium sulfate; lithopone; metal salts of fatty acids; powdered fluoropolymers; polytetrafluoroethylene; polyethylene powder; carbon black; silicon carbide; silicon nitride; and powdered or fine particle polymers.

The toner may be formulated for use in mono component or dual component systems. When the toner will be employed in a dual component system, the toner particles will be further combined with a carrier material. These materials are well known in the industry and are chosen to satisfy the print engine mechanics. Some common carrier materials include ferrite carriers, coated ferrite carriers, steel shot, iron powders, and steel powders, coated and uncoated.

The present toners may be made by suspension polymerization or a direct particle formation process. The toner composition in keeping with this invention may be formulated in the following manner. This formulation processing, however, is intended to be merely exemplary and in no way limits the means of formulating a color toner consistent with the limitations of the appended claims and any equivalents thereof.

For example, in a suspension polymerization process for producing a toner according to the present embodiments, a monomer mixture is first obtained by mixing uniformly the sublimable dye with or without non-sublimable pigment colorants, the polymerizable monomer component, a preformed polymer resin component, the wax, charge control agent and the like. Before dispersing the organic monomer mixture into an aqueous, optional polymerization initiator is added to the monomer mixture. This is followed by adding the resulting organic mixture into an aqueous dispersion medium, and then dispersing the organic mixture in the aqueous dispersion medium. The preformed polymer resin component is added to minimize toner transferred to secondary substrate. Therefore, the preferred preformed polymer resin component is comprised of high molecular polymers, branched polymers and crosslinked polymers. These preformed polymer should be soluble in the monomer component. The preferred composition for the monomer mixture is shown in the following Table.

| Organic monomer mixture | Weight percent |
|---|---|
| Monomer | 60-94 |
| Preformed polymer | 0-15 |
| Charge control agent | 1-5 |
| Sublimable dye | 5-15 |
| Non-sublimable pigment | 0-5 |
| Initiator | 0-5 |

The method for uniformly mixing these ingredients of the monomer composition is not limited. The most preferable method for dispersing uniformly colorant in the polymerizable monomer component is to mill and disperse the colorant and the like in the polymerizable monomer component with a medium type dispersive apparatus such as ball mill. The preformed polymer resin component is first dissolved in the monomer component and then he colorant, wax, charge control agent and optional additives other than a polymerization initiator are added, and these components are stirred and mixed with means such as a ball-mill to give an organic monomer mixture comprising the individual components dissolved or dispersed uniformly therein. The organic monomer mixture is poured into the aqueous dispersion medium containing a dispersant, and then the polymerization initiator is added to the aqueous dispersion medium with stirring with a mixing machine.

As a mixing machine, a high speed rotative shearing type mixer is preferable, in which the high speed rotative shearing type mixer has a high speed rotatable turbine and a stator having radial baffles, and functions such that the mixture is inhaled from a suction port of the stator under the pressure difference between the upper and bottom of the turbine resulting from high speed rotation, is imparted stress such as shear, impact, cavitations and the like in a high speed rotated turbine, and is extruded through an extrusion port of the stator. The other preferred mixer is a high speed rotation type homogenizers such as the CLEARMIX of Organo Coporation and POLYTRON of Brinkmann. Another preferred mixer is a high pressure homogenizers such the GAULIN homogenizer and Microfluidizer of Microfluidics.

In this dispersing and mixing step, droplets of the monomer mixture are brought into contact with droplets of the polymerization initiator, so that the droplets of the monomer mixture and the droplets of the polymerization initiator unite with each other, whereby droplets of a monomer composition containing the polymerization initiator, the colorants, and other additives and the polymerizable monomer component are formed. The time the polymerization initiator is added to the aqueous dispersion medium is generally after the monomer mixture is poured and in the course of forming droplets of the monomer mixture. When the polymerization initiator is added after the monomer mixture is formed into fine droplets having desired droplet sizes in the aqueous dispersion medium, the polymerization initiator is difficult to uniformly mix with such droplets. The time the polymerization initiator is added is when the droplet size (volume average droplet size) of the primary droplets formed by the stirring after the pouring of the monomer mixture reaches generally 50 to 1,000 μm, preferably 100 to 500 μm, though the time varies according to the intended particle size of the resulting toner.

When the period of the time from the pouring of the monomer mixture to the addition of the polymerization initiator is long, the formation of the droplets has been completed, so that the monomer mixture is not uniformly mixed with the polymerization initiator, resulting in difficulty in making resin properties such as the polymerization degree and crosslinking degree uniform for every polymerized toner particle. Therefore, the time the polymerization initiator is added is preferably not later than generally 24 hours, more preferably 3 hours after the pouring of the monomer mixture on a large scale such as plant, or not later than generally 5 hours, more preferably 1 hour on a small laboratory scale though it somewhat varies according to reaction scale and the intended particle size of the resulting toner.

The temperature of the aqueous dispersion medium between the time the polymerization initiator is added and the subsequent formation of droplets (namely, before initiation of polymerization) is preferably controlled within a range of generally 10 to 40° C., preferably 20 to 30° C. If the temperature is too high, a partial polymerization reaction is started in the dispersion. If the temperature is too low on the other hand, the flowability of the dispersion is reduced when droplets are formed by stirring, resulting in the possibility that formation of the droplets is inhibited. After the droplets of the monomer mixture are brought into contact with the droplets of the polymerization initiator, the stirring is further continued to form secondary droplets of the monomer composition containing the polymerization initiator, the colorant and the polymerizable monomer component, the stirring is further continued to form secondary droplets having desired droplet sizes, and then suspension polymerization of the polymerizable monomer component is then conducted.

In the step of forming the secondary droplets, the secondary droplets are finely divided to such an extent that in the subsequent suspension polymerization, a polymerized toner having a volume average particle size of generally about 1 to 50 μm, preferably about 3 to 30 μm, more preferably 5 to 10 μm is formed. The time the secondary droplets are formed can be optionally set according to the nature and added amounts of the polymerizable monomer component, additives, polymerization initiator and the like, the temperature upon the formation of the droplets, the kind of machine used in the formation of the droplets, and desired droplet sizes.

The aqueous dispersion medium may be water, preferably water containing a dispersant. As the dispersant used in the present invention, examples are a sulfate such as barium sulfate, calcium sulfate; a carbonate such as barium carbonate, calcium carbonate, magnesium carbonate; a phosphate such as calcium phosphate; a inorganic oxide such as silica, aluminium oxide, titanium oxide; a metal hydroxide such as aluminium hydroxide, magnesium hydroxide, iron hydroxide; a water-soluble polymer such as polyvinylalcohol, methyl cellulose and gelatin; a surfactant such as anionic surfactant, nonionic surfactant and amphoteric surfactant and the like. Among these dispersants, a dispersant comprising a colloid of a water-insoluble metal hydroxide, which can narrow down the distribution of toner particle size, is preferable for enhancing the sharpness of pictures.

Direct particle formation is another preferred process for making the dye sub toners. This process comprises the following steps: a) blending at least a sublimation dye, an optional non-sublimable pigment, a polymer binder, a wax, a charge control agent, in an organic solvent to give an organic phase; b) dispersing the organic phase in an aqueous phase containing a dispersant and mixing the organic phase and the aqueous phase at an elevated temperature and under shear force to form toner particles of a controlled size and shape; c) removing the organic solvent, particulate stabilizer, and interface promoter, if used, from the formed particles; and d) washing, drying, and collecting the particles for use as a dry toner powder. Examples of direct particle formation processes include limited coalescence process such as that disclosed in U.S. Pat. No. 4,833,060 and chemical milling process such as that disclosed in US 2004/0161687.

One particularly preferred toner composition according to the present embodiments has the following formulation, wherein percentages are by weight:

| Component | Weight percent |
|---|---|
| Polymer binder | 70-90 |
| Wax | 1-15 |
| Charge control agent | 1-5 |
| Sublimable dye | 5-15 |
| Non-sublimable pigment | 0-5 |

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

What is claimed is:

1. A toner composition for use in dye sublimation printing applications, said toner composition comprising toner particles including a polymer binder, a wax, a charge control agent, a sublimable dye, and an optional non-sublimable pigment.

2. A toner composition according to claim 1, wherein said polymer binder comprises at least one of a polyamide, polyolefin, styrene polymer, polyester or copolymer thereof.

3. A toner composition according to claim 1, wherein the molecular weight of the polymer is at least about 50,000.

4. A toner composition according to claim 3, wherein the molecular weight of the polymer is at least about 300,000.

5. A toner composition according to claim 1, wherein said non-sublimable pigment comprises at least one of an azo pigment, phthalocyanine, or quinacridone.

6. A toner composition according to claim 1, wherein said wax comprises an amide wax, a polyolefin wax, carnauba was, and candelilla wax.

7. A toner composition according to claim 6, wherein said amide wax comprises an ethylene bis(stearamide).

8. A toner composition according to claim 1, wherein said sublimable dye comprises at least one of a nitroarylamine, azo or anthraquinone compound.

9. A toner composition according to claim 1, wherein said toner comprises, by weight, 70-90% polymer binder, 1-5% wax, 1-5% charge control agent, 5-10% sublimable dye, and 2-5% non-sublimable pigment.

10. A toner composition according to claim 1, wherein said toner comprises particles having a volume average particle size of from 5 to 10 μm.

11. A toner composition according to claim 1, wherein said toner is a chemically produced toner.

12. A toner composition according to claim 1, wherein said toner is produced by a suspension polymerization or direct particle formation process.

13. A toner composition according to claim, 1 wherein said toner is further combined with at least one external post-additive agent.

14. A toner composition according to claim 13, wherein said post-additive agent comprises at least one of a hydrophobic silica fine powder and a hydrophobic titanium oxide powder.

15. A process for forming a toner particle comprising the steps of: a) blending at least a sublimation dye, an optional non-sublimable pigment, a polymer binder, a wax, and a charge control agent in a organic solvent to give an organic phase; b) dispersing the organic phase in an aqueous phase containing a dispersant and mixing the organic phase and the aqueous phase at elevated temperature and under shear force to form toner particles of a controlled size and shape; c) removing the organic solvent, particulate stabilizer, and interface promoter, if used, from the formed particles; and d) washing, drying, and collecting the particles.

16. A process for forming a toner particle comprising the steps of: a) mixing a sublimable dye, a monomer, a wax, and a charge control agent to form a monomer mixture; b) dispersing said monomer mixture into an aqueous solution containing a dispersant; c) forming droplets containing said monomer, said dye and a polymerization initiator; d) polymerizing said monomer to form toner particles; and e) washing, drying, and collecting the particles.
